(19) United States
(12) Patent Application Publication
(10) Pub. No.: US 2016/0164144 A1
(43) Pub. Date: Jun. 9, 2016

(54) APPLICATION OF BINDERLESS ZEOLITE MOLECULAR SIEVES FOR THE DRYING OF CARBONATES USED AS ELETROLYTIC SOLVENTS

(71) Applicant: BASF SE, Ludwigshafen (DE)

(72) Inventors: Agnes VOITL, Schifferstadt (DE); Itamar Michael MALKOWSKY, Speyer (DE); Axel KIRSTE, Limburgerhof (DE); Lothar KARRER, Pfungstadt (DE)

(73) Assignee: BASF SE, Ludwigshafen (DE)

(21) Appl. No.: 14/903,544

(22) PCT Filed: Jul. 10, 2014
(86) PCT No.: PCT/EP2014/064802

§ 371 Date: Jan. 7, 2016

(30) Foreign Application Priority Data
Jul. 11, 2013 (EP) 13176172.8

(51) Int. Cl. H01M 10/0569; H01M 10/052

(52) U.S. Cl. CPC H01M 10/0569; H01M 10/052; H01M 2300/0037

(57) ABSTRACT

Method for producing a dehydrated liquid mixture comprising water in an amount of less than 20 ppm, for use as a solvent for a conducting salt, comprising or consisting of the following steps: —providing or preparing a liquid starting mixture comprising—a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture, —water in a total amount of 3500 ppm to 20 ppm, based on the total amount of the liquid starting mixture, —optionally further constituents, —contacting the liquid starting mixture with an amount of a binderless zeolite molecular sieve such that the water content in the mixture is reduced to an amount of less than 20 ppm, based on the total amount of the dehydrated liquid mixture.

The present invention relates to a method for producing a dehydrated liquid mixture comprising water in an amount of less than 20 ppm, for use as a solvent for a conducting salt.

Another aspect of the present invention relates to a method of producing an electrolyte mixture.

Dehydrated liquid mixtures comprising water in an amount of less than 20 ppm for use as a solvent for a conducting salt are for example needed in lithium ion batteries.

In lithium ion batteries an electrolyte mixture is present which comprises a conducting lithium salt and a dehydrated liquid solvent mixture, wherein the conducting salt is dissolved in the dehydrated liquid solvent mixture. Such solvents in the dehydrated liquid solvent mixture are usually organic carbonates (e.g. ethylene carbonate (EC), ethyl methyl carbonate (EMC), propylene carbonate (PC)). These organic carbonates are usually only commercially available exhibiting an initial water content in the range of from 100 to 1000 ppm.

However, the presence of water in lithium ion batteries usually causes undesired effects. When water is present in the electrolyte mixture of a lithium ion battery, not only the negative electrode performance of the battery is reduced but also decomposition of the conducting salt in the electrolyte mixture is accelerated. Although various conducting salts are known, lithium hexafluorophosphat (LiPF₆) is widely used in lithium ion batteries.

Neumann (Chemie Ingenieur Technik, 2011, 83, No. 11, 2042-2050) provides a general overview article regarding lithium ion secondary batteries. The document discloses that lithium hexafluorophosphat (LiPF₆) requires the absence of water. The reason is that LiPF₆ easily decomposes in the presence of water and forms hydrofluoric acid (HF) which causes massive corrosion in the battery. However, Neumann does not disclose any method to reduce the water content in a liquid mixture comprising one or more organic carbonates in order to avoid formation of hydrofluoric acid.

It is generally accepted that the amount of water in the electrolyte mixture of lithium ion batteries needs to be 50 ppm or less to minimize the aforementioned effects. Therefore, removal of water from the electrolyte mixture or the liquid mixture meant as a solvent for the lithium conducting salt by a dehydration (removal of water) step is in many cases a significant step.

Examples of dehydration (i.e. removal of water) methods include (i) a method of separately drying a liquid solvent mixture (to obtain a dehydrated liquid solvent mixture) and a conducting salt and then mixing both to prepare an electrolyte mixture or (ii) a method of drying a mixture of a liquid solvent mixture and a conducting salt. The removal of water is for example conducted by using a desiccant, such as a zeolite, and/or by distillation.

For example, document Pahl et al. (Chemie Ingenieur Technik, 2010, 82, No. 5, 634-640) relates to the adsorptive removal of water from primary alcohols by means of zeolites. The document discloses that water can be efficiently removed (down to a low ppm range) by adsorption at molecular sieves such as zeolites of type 3A or 4A. However, document Pahl et al. is silent with respect to reducing the water content in a liquid mixture comprising one or more organic carbonates.

In this context it needs to be considered that usually an ion-exchangeable cation is present in a zeolite. If a zeolite is used for dehydrating a mixture of a liquid solvent mixture and a lithium conducting salt, the cation of the zeolite can cause an ion exchange reaction with the lithium ions during the dehydration process, contaminating the dehydrated electrolyte mixture.

Such ion exchange reactions can be avoided by drying method (i), wherein the liquid solvent mixture is separately dried (i.e. in the absence of a conducting salt) or by a specific type of method (ii) namely by applying a lithium zeolite, i.e. a zeolite wherein the original ion-exchangeable cation is ion-exchanged with lithium ions and therefore suited for drying in the presence of a lithium conducting salt.

US 2012/0141868 A1 discloses a lithium zeolite for treatment of nonaqueous electrolytic solutions and a treatment method of nonaqueous electrolytic solutions. The document discloses that on the basis of a method of type (i) the water amount can hardly be reduced to 50 ppm or less.

CN 1338789 A relates to a process for preparing organic carbonate solvents used for secondary lithium battery. The document discloses that a kind of organic carbonate solvents for secondary lithium battery is prepared by flowing organic carbonate through a drying column containing drying agent which may be for example molecular sieve for dewatering it, distilling in distillation tower at 50-200° C. and −0.05 to 0.1 MPa, and separating distillate. The document reports that the advantages are high purity up to 99.9% or more and low water content (lower than 5 ppm). However, the process is complicated as it includes both an adsorption and a distillation step.

Furthermore, drying methods of type (i) are often negatively affected by the zeolites used. In order to form mechanically stable shaped bodies (e.g. granules, pellets, etc) the zeolite material (powder) is typically mixed with a binder to compensate for the low binding affinity of the zeolite powder particles (the powder is the synthesis product of synthetic zeolite production). Examples of binders typically used include silica, alumina and clay. Typical clays include kaolin-type, bentonite-type, talc-type, pyrophyllite-type, molysite-type, vermiculite-type, montmorillonite-type, chlorite-type and halloysite-type clays.

Such binder is not particularly limited in its amount added but is often added in an amount of 10 to 50 parts by weight per 100 parts by weight of zeolite powder particles. If the amount of the binder added is less than 10 parts by weight per 100 parts by weight of zeolite powder particles, the mechanically stable shaped bodies may collapse during use, whereas if it exceeds 50 parts by weight, the dehydration capacity (i.e. drying capacity) becomes insufficient.

A major problem is that such binders usually contain large quantities of releasable ions (e.g. aluminium ions), which can contaminate the mixture to be dried (metal leaching).

In order to reduce contamination of the mixture to be dehydrated, mechanically stable shaped bodies of binderless zeolites can be used. In order to form mechanically stable shaped bodies (e.g. granules, pellets, etc) from zeolite powder a binder is “used”. After formation of mechanically stable shaped bodies the binder is converted into a zeolite during the process of forming mechanically stable shaped bodies (formation of a binderless zeolite molecular sieve) e.g. by caustic digestion. By such a conversion (also named zeolitisation), the proportion of zeolite contained in the mechanically stable shaped bodies can be increased and ultimately, the mechanically stable shaped bodies can be composed entirely of zeolite.

Schuhmann et al. (Chemie Ingenieur Technik 2011, 83, No. 12, 2237-2243) disclose binderless zeolite molecular sieves of the LTA and FAU type. However, the document does not disclose the use of binderless zeolite molecular sieves in order to reduce the water content to a very low amount of e.g. less than 20 ppm in a liquid mixture comprising one or more organic carbonates.

As a consequence, there is an ongoing demand for methods for producing dehydrated liquid solvent mixtures comprising water in an amount of less than 20 ppm, for use as a solvent for a conducting salt, in particular a lithium conducting salt. Preferably, such dehydrated liquid solvent mixtures should not be contaminated by the presence of ions.

It was, therefore, a first object of the present invention to provide a method for producing a dehydrated liquid mixture comprising water in an amount of less than 20 ppm, for use as a solvent for a conducting salt, starting from a liquid starting mixture comprising a total amount of 90% by weight or more, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture, water in a total amount of 3500 ppm to 20 ppm, based on the total amount of the liquid starting mixture, and optionally further constituents.

It was another object of the present invention to provide a method, wherein the dehydrated liquid mixture to be produced is of high purity and thus contributes to a prolonged life time of the lithium ion battery and therefore generally to a better quality of these batteries.

According to a first aspect, the present invention provides a method for producing a dehydrated liquid mixture comprising water in an amount of less than 20 ppm, for use as a solvent for a conducting salt, comprising or consisting of the following steps:
providing or preparing a liquid starting mixture comprising
   a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture,
   water in a total amount of 3500 ppm to 20 ppm, preferably in a total amount of 500 ppm to 20 ppm, based on the total amount of the liquid starting mixture,
   optionally further constituents,
contacting the liquid starting mixture with an amount of a binderless zeolite molecular sieve such that the water content in the mixture is reduced to an amount of less than 20 ppm, based on the total amount of the dehydrated liquid mixture.

Throughout this text the term “C1 to C8 alcohols” indicates alcohols having 1 to 8 carbon atoms. Preferably, a C1 to C8 alcohol is (i) aliphatic, (ii) substituted or unsubstituted, and (iii) branched or unbranched.

Furthermore, throughout this text the term “further constituents” indicates constituents other than water, organic carbonates, acetic acid esters of C1 to C8 alcohols and butyric acid esters of C1 to C8 alcohols.

Preferred acetic acid esters of C1 to C8 alcohols are acetic acid methyl ester and acetic acid ethyl ester. Preferred butyric acid esters of C1 to C8 alcohols are butyric acid methyl ester and butyric acid ethyl ester.

Preferably, in the method according to the invention (as described above, in particular in a method described as being preferred) the total amount of acetic acid esters of C1 to C8 alcohols and butyric acid esters of C1 to C8 alcohols is in the range of from 0 to 33.4% by weight, based on the total amount of the liquid starting mixture.

Preferred is a method according to the invention (as described above, in particular a method described as being preferred), wherein
the total amount of acetic acid esters of C1 to C8 alcohols and butyric acid esters of C1 to C8 alcohols is in the range of from 0 to 45% by weight, preferably in the range of from 0 to 33.4% by weight, based on the total amount of the liquid starting mixture,
   and/or
the liquid starting mixture comprises water in a total amount of 3500 ppm to 20 ppm, preferably in a total amount of 500 ppm to 20 ppm, based on the total amount of the liquid starting mixture.

Preferred is a method according to the invention (as described above, in particular a method described as being preferred), wherein the total amount of acetic acid esters of C1 to C8 alcohols and butyric acid esters of C1 to C8 alcohols is in the range of from 0 to 10% by weight, and preferably is 0% by weight, based on the total amount of the liquid starting mixture. E.g., if the total amount of acetic acid esters of C1 to C8 alcohols and butyric acid esters of C1 to C8 alcohols is 0% by weight (or, e.g., 5% by weight), the total amount of organic carbonates is 90% by weight (or, e.g., 85% by weight, respectively) or more, based on the total amount of the liquid starting mixture.

Correspondingly, preferred is a method (as described above, in particular in a method described as being preferred) for producing a dehydrated liquid mixture comprising water in an amount of less than 20 ppm, for use as a solvent for a conducting salt, comprising or consisting of the following steps:
providing or preparing a liquid starting mixture comprising
   one, two, three or more organic carbonates in a total amount of 90% by weight or more, based on the total amount of the liquid starting mixture,
   water in a total amount of 3500 ppm to 20 ppm, preferably in a total amount of 500 ppm to 20 ppm, based on the total amount of the liquid starting mixture,
   optionally further constituents,
contacting the liquid starting mixture with an amount of a binderless zeolite molecular sieve such that the water content in the mixture is reduced to an amount of less than 20 ppm, based on the total amount of the dehydrated liquid mixture.

A significant and unexpected advantage of the method of the present invention is that it allows to reduce the water content to less than 20 ppm by means of a single step of contacting the liquid starting mixture with a binderless zeolite molecular sieve.

Another advantage of this invention is a high purity of the dehydrated liquid mixture produced, i.e. no significant metal leaching by release of ions from the binder of the binderless zeolite molecular sieve takes place. As a consequence, the life time of a corresponding lithium ion battery is usually prolonged.

The term “molecular sieve” as used in the art indicates a class of substances with discrete pore structures that can act as an adsorbent, discriminating between molecules on the basis of size.

The term “zeolite molecular sieve” as used in the art indicates a specific class of molecular sieves, wherein the substances mainly comprise alkali metal crystalline aluminosilicates with a framework structure, exhibiting the general formula M_{x/n} [(AlO₂)ₓ(SiO₂)_{y}]zH₂O, wherein “M” represents the nonframework metal cation, and “n” is its charge. Synthetic and natural zeolites are known. Natural zeolites are for example clinoptilolite and chabazite. Synthetic zeolites are for example zeolite 4A, zeolite P and zeolite ZSM-5. All these zeolites exhibit as small a pore size as about 6 Angstrom or less and, among others, zeolite 4A has a 8-membered ring pore structure giving a pore size of even 4 Angstrom. For a more detailed definition and discussion of zeolites reference is made to the January 1975 publication of the International Union of Pure and Applied Chemistry entitled “Chemical Nomenclature, and Formulation of Compositions, of Synthetic and Natural Zeolites”.

The term “binderless zeolite molecular sieve” as used in the art indicates a zeolite molecular sieve wherein the total amount of alkali metal crystalline aluminosilicates with a framework structure (as defined above) is preferably 95 to 100% by weight (usually almost 100% by weight), based on the total amount of the binderless zeolite molecular sieve, which means that no significant amount of binder is contained in the binderless zeolite molecular sieve.

Own studies have indicated that in methods according to the invention (as described above) the use of a binderless zeolite molecular sieve advantageously reduces the effect of metal leaching.

Typically, in methods conducted according to the present invention in the dehydrated liquid mixture the total amount of aluminium ions was less than 1 ppm and the total amount of silicon ions was also less than 1 ppm. Typically, in methods conducted according to the present invention even the total amount of aluminium ions plus silicon ions in the dehydrated liquid mixture was less than 1 ppm.

Thus, in the method according to the invention (as described above, in particular in methods described as being preferred), the dehydrated liquid mixture produced preferably contains an amount of aluminium ions of less than 2 ppm, more preferably of less than 1 ppm.

It is also preferred that in the method according to the invention (as described above, in particular in methods described as being preferred), the dehydrated liquid mixture preferably contains an amount of silicon ions of less than 2 ppm, more preferably of less than 1 ppm.

Even more preferred in the method according to the invention (as described above, in particular in methods described as being preferred) is that the total amount of aluminium ions plus silicon ions in the dehydrated liquid mixture is less than 2 ppm, more preferably less than 1 ppm.

Typically, if not indicated otherwise throughout this text, the ion concentration was quantitatively determined by GC (gas chromatography) combined with ICP-MS (inductively coupled plasma mass spectrometry) measurements. The skilled person is aware of the practical requirements to be met in order to arrive at reliable results. Furthermore, the skilled person knows that gas chromatographic measurements can also be combined with ICP-AES (inductively coupled plasma atomic emission spectroscopy) in order to quantitatively determine the ion concentrations.

Throughout the specification, the water concentration (amount of water in the liquid starting mixture and the dehydrated liquid mixture, respectively) is determined quantitatively by coulometric Karl Fischer measurement, if not indicated otherwise.

Throughout the specification, the term “ppm” denotes a mass fraction, if not indicated otherwise.

Preferably, in the method according to the invention (as described above, in particular in methods described as being preferred) the contacting step is conducted at a temperature in the range of from −20 to 100° C., more preferably at a temperature in the range of from −20 to 60° C., most preferably at a temperature in the range of from −20 to 40° C.

Preferably, in the method according to the invention (as described above, in particular in methods described as being preferred) the contacting step is conducted at a pressure of maximum 50 bar, preferably in the range of from very close to zero to 50 bar, more preferably in the range of from 0.5 to 10 bar, most preferably at a pressure in the range of from 1 to 1.5 bar.

In the method according to the invention (as described above, in particular in methods described as being preferred) the contacting step is even more preferably conducted at a temperature in the range of from −20 to 40° C. and at a pressure in the range of from 1 to 1.5 bar. Most preferably, the aforementioned features regarding the total amounts of aluminium ions and silicon ions apply too.

Also, if the liquid starting mixture solidifies at least partially in the temperature range of from −20° C. to 60° C. (preferably in the temperature range of from 20 to 60° C.), preferred is a method, wherein the contacting step is conducted at a temperature in the range of from 0 to 30 Kelvin, preferably 0 to 20 Kelvin, above the corresponding solidification temperature of the liquid starting mixture.

In some cases, it is preferred that the method according to the invention (as described above, in particular in methods described as being preferred) consists of the following steps:
providing or preparing a liquid starting mixture comprising
   one, two, three or more organic carbonates in a total amount of 90% by weight or more, based on the total amount of the liquid starting mixture,
   water in a total amount of 3500 ppm to 20 ppm, preferably in a total amount of 500 ppm to 20 ppm, based on the total amount of the liquid starting mixture,
   optionally further constituents,
contacting the liquid starting mixture with an amount of a binderless zeolite molecular sieve such that the water content in the mixture is reduced to an amount of less than 20 ppm, based on the total amount of the dehydrated liquid mixture.

Even more preferably, in these cases (i) the aforementioned features regarding the total amounts of aluminium ions and silicon ions and/or the aforementioned features regarding temperature and/or pressure (ii) and/or one or more features of additional embodiments following hereafter apply.

An organic carbonate is often also referred to as carbonate ester, or organocarbonate, and is a diester of carbonic acid. In the method according to the invention (as described above, in particular in methods described as being preferred) the one organic carbonate or each of the two, three or more organic carbonates is preferably a monomeric organic carbonate, i.e. the one organic carbonate or each of the two, three or more organic carbonate is not a polycarbonate.

The dehydrated liquid mixture to be produced, i.e. the dehydrated liquid mixture comprising water in an amount of less than 20 ppm, preferably is suitable for use as a solvent for a lithium conducting salt, preferably LiPF₆.

Preferably, in the method according to the invention (as described above, in particular in methods described as being preferred), the one organic carbonate or each of the two, three or more organic carbonates, respectively, is a compound of Formula (I)

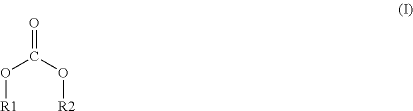

wherein independently for each of said organic carbonates
R1 and R2 independently of each other denote an alkyl group having one or more carbon atoms
   or
R1 and R2 together constitute a substituted or unsubstituted alkylene bridge linking the esterified oxygens of the diester.

In some cases it is preferred that the alkylene bridge linking the esterified oxygens of the diester is unsubstituted. However, in other cases it is preferred that one or more hydrogen atoms of the alkylene bridge linking the esterified oxygens of the diester are substituted, wherein the substituents are selected from the group consisting of halogen, alkylidene, vinyl and alkyl. Preferred are substituents selected from the group consisting of F, Cl, Br, I, methylidene, ethylidene, vinyl, methyl, ethyl and propyl, more preferably F, Cl, methylidene, methyl, vinyl and ethyl.

Preferably, in the method according to the invention (as described above, in particular in methods described as being preferred) the total number of carbon atoms in R1 plus R2 is in the range of from 2 to 10, more preferably in the range of from 2 to 6, most preferably in the range of from 2 to 4.

If R1 and R2 independently of each other denote an alkyl group, preferably one or each of R1 and R2 independently of each other comprise a number of carbon atoms in the range of from 1 to 5, more preferably in the range of from 1 to 3, most preferably in the range of from 1 to 2.

An unsubstituted alkylene bridge linking the esterified oxygens of the diester is a functional group of formula —(CH₂)ₙ—, wherein n is a positive integer, preferably a positive integer in the range of from 2 to 10, more preferably in the range of from 2 to 6, even more preferably in the range of from 2 to 4, wherein most preferably n is 2. The dashes “-” in the formula indicate the bonds to the esterified oxygens of the diester.

Preferably, in the method according to the invention (as described above, in particular in methods described as being preferred) in a substituted alkylene bridge linking the esterified oxygens of the diester the total number of carbon atoms (in R1 plus R2) is in the range of from 2 to 10, more preferably in the range of from 2 to 6, even more preferably in the range of from 2 to 4, and wherein most preferably the number of carbon atoms in the main chain of the bridge linking the esterified oxygens of the diester is 2.

In some cases, a preferred organic carbonate, wherein R1 and R2 together constitute a substituted alkylene bridge linking the esterified oxygens of the diester is a compound of Formula (Ia)

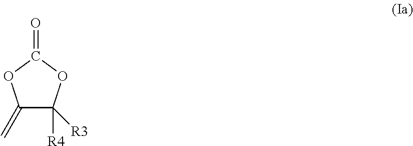

wherein R3 and R4 independently of each other are selected from the group consisting of hydrogen and alkyl, preferably hydrogen, methyl, ethyl and propyl, more preferably hydrogen, methyl and ethyl. If both R3 and R4 are hydrogen, the compound is 4-methylene-1,3-dioxolan-2-one.

Preferably, in the method according to the invention (as described above, in particular in methods described as being preferred), the one organic carbonate or each of the two, three or more organic carbonates, respectively, is a compound of Formula (I)

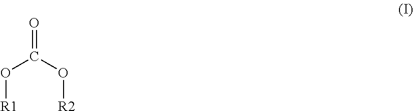

wherein independently for each of said organic carbonates
R1 and R2 independently of one another denote an alkyl group selected from the group consisting of methyl, ethyl, n-propyl, isopropyl, n-butyl, isobutyl, tert.-butyl, sec.-butyl, n-pentyl (amyl), 2-pentyl (sec.-pentyl), 3-pentyl, 2-methylbutyl, 3-methylbutyl (isopentyl), 3-methylbut-2-yl, 2-methylbut-2-yl and 2,2-dimethylpropyl (neopentyl), preferably selected from the group consisting of methyl and ethyl.

Preferably, in the method according to the invention (as described above, in particular in methods described as being preferred) the one organic carbonate or each of the two, three or more organic carbonates, respectively, is selected from the group consisting of dimethyl carbonate, diethyl carbonate, ethyl methyl carbonate, propylene carbonate, fluoroethylene carbonate, 4,4-dimethyl-5-methylene-1,3-dioxolan-2-one, 4-methyl-5-methylene-1,3-dioxolan-2-one, 4-methylene-1,3-dioxolan-2-one, vinyl ethylene carbonate and ethylene carbonate, preferably selected from the group consisting of ethylene carbonate, diethyl carbonate, ethyl methyl carbonate, dimethyl carbonate, fluoroethylene carbonate and propylene carbonate.

This means that the one organic carbonate or each of the two, three or more organic carbonates, respectively, is preferably selected from the group consisting of

| | | | total number of |
|---|---|---|---|
| | | | carbon atoms in |
| | | | R1 plus R2/total |
| | | | number of carbon |
| | | | atoms in main |
| | | | chain of bridge |
| | | | (i.e. total number |
| | | | of carbon atoms in |
| | | | R1 plus R2 minus |
| | | | carbon atoms in side |
| compound | structural formula | R1, R2 | chain of bridge) |
| dimethyl carbonate | 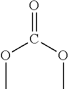 | R1 = R2 = methyl | 2/- |
| diethyl carbonate | 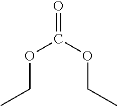 | R1 = R2 = ethyl | 4/- |
| ethyl methyl carbonate | 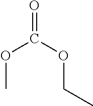 | R1 = methyl R2 = ethyl | 3/- |
| ethylene carbonate | 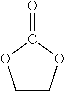 | R1 plus R2 = unsubstituted alkylene bridge = ethylene bridge | 2/2 |
| propylene carbonate | 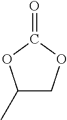 | R1 plus R2 = substituted alkylene bridge, substituent: methyl | 3/2 (i.e.1 carbon atom in side chain) |
| 4,4-dimethyl- 5-methylene- 1,3-dioxolan- 2-one | 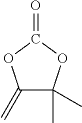 | R1 plus R2 = substituted alkylene bridge, substituents: methylidene, methyl, methyl | 5/2 (i.e.3 carbon atoms in side chain) |
| 4-methyl-5- methylene- 1,3-dioxolan- 2-one | 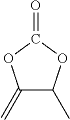 | R1 plus R2 = substituted alkylene bridge, substituents: methylidene, methyl | 4/2 (i.e.2 carbon atoms in side chain) |
| 4-methylene- 1,3-dioxolan- 2-one | 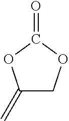 | R1 plus R2 = substituted alkylene bridge, substituent: methylidene | 3/2 (i.e.1 carbon atom in side chain) |
| fluoroethylene carbonate | 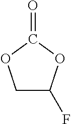 | R1 plus R2 = substituted alkylene bridge, substituent: F | 2/2 |
| vinyl ethylene carbonate (4-vinyl-1,3- dioxolan- 2-one) | 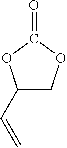 | R1 plus R2 = substituted alkylene bridge, substituent: vinyl | 4/2 (i.e.2 carbon atoms in side chain) |

Preferably, a liquid starting mixture (as described above, in particular a mixture described as being preferred) comprises two, three or four organic carbonates in a total amount of 90% by weight or more, based on the total amount of the liquid starting mixture, more preferably two, three or four organic carbonates selected from the group consisting of dimethyl carbonate, diethyl carbonate, ethyl methyl carbonate, propylene carbonate, fluoroethylene carbonate, 4,4-dimethyl-5-methylene-1,3-dioxolan-2-one, 4-methyl-5-methylene-1,3-dioxolan-2-one, 4-methylene-1,3-dioxolan-2-one, vinyl ethylene carbonate and ethylene carbonate, preferably combinations of carbonates indicated in the following tables, and more preferably in the amounts and ratios also indicated in the following tables. In the tables, “% by weight” relates to the total amount of said organic carbonates in the liquid starting mixture:

(i) liquid starting mixtures comprising two organic carbonates:

| Carbonate 1 | Carbonate 2 | % by weight | |
|---|---|---|---|
| ethylene carbonate | ethyl methyl carbonate | 50 | 50 |
| ethylene carbonate | ethyl methyl carbonate | 30 | 70 |
| ethylene carbonate | dimethyl carbonate | 50 | 50 |
| ethylene carbonate | dimethyl carbonate | 30 | 70 |
| ethylene carbonate | diethyl carbonate | 50 | 50 |
| ethylene carbonate | diethyl carbonate | 30 | 70 |
| propylene carbonate | ethyl methyl carbonate | 50 | 50 |
| propylene carbonate | ethyl methyl carbonate | 75 | 25 |
| fluoroethylene carbonate | dimethyl carbonate | 20 | 80 |

(ii) liquid starting mixtures comprising three organic carbonates:

| Carbonate 1 | Carbonate 2 | Carbonate 3 | % by weight | | |
|---|---|---|---|---|---|
| ethylene | ethyl methyl | dimethyl | 33⅓ | 33⅓ | 33⅓ |
| carbonate | carbonate | carbonate | | | |
| ethylene | ethyl methyl | dimethyl | 30 | 40 | 30 |
| carbonate | carbonate | carbonate | | | |
| ethylene | diethyl | dimethyl | 33⅓ | 33⅓ | 33⅓ |
| carbonate | carbonate | carbonate | | | |
| fluoroethylene | diethyl | dimethyl | 33⅓ | 33⅓ | 33⅓ |
| carbonate | carbonate | carbonate | | | |
| fluoroethylene | diethyl | dimethyl | 20 | 40 | 40 |
| carbonate | carbonate | carbonate | | | |
| ethylene | dimethyl | fluoroethylene | 33⅓ | 33⅓ | 33⅓ |
| carbonate | carbonate | carbonate | | | |
| ethylene | propylene | ethyl methyl | 20 | 20 | 60 |
| carbonate | carbonate | carbonate | | | |
| ethylene | propylene | dimethyl | 20 | 20 | 60 |
| carbonate | carbonate | carbonate | | | |
| ethylene | propylene | dimethyl | 25 | 15 | 60 |
| carbonate | carbonate | carbonate | | | |
| ethylene | propylene | dimethyl | 42.5 | 15 | 42.5 |
| carbonate | carbonate | carbonate | | | |
| ethylene | dimethyl | ethyl acetate | 33⅓ | 33⅓ | 33⅓ |
| carbonate | carbonate | | | | |

(iii) liquid starting mixtures comprising four organic carbonates:

| Carbonate | Carbonate | Carbonate | Carbonate | | | | |
|---|---|---|---|---|---|---|---|
| 1 | 2 | 3 | 4 | % by weight | | | |
| ethylene | propylene | dimethyl | ethyl methyl | 25 | 11 | 44 | 20 |
| carbonate | carbonate | carbonate | carbonate | | | | |
| ethylene | propylene | dimethyl | ethyl methyl | 50 | 12.5 | 12.5 | 25 |
| carbonate | carbonate | carbonate | carbonate | | | | |

The aforementioned organic carbonates are often used in a liquid solvent mixture for a lithium conducting salt. In some cases ethylene carbonate and/or propylene carbonate are used as major solvent. However, ethylene carbonate shows high viscosity at room temperature (25° C.) so that additional organic carbonates are added in order to lower the viscosity at room temperature, e.g. dimethyl carbonate, diethyl carbonate, and/or ethyl methyl carbonate are added. Such mixtures, comprising one or more major solvents as well as additional organic carbonates in order to lower the viscosity are well usable/processible at room temperature.

Preferably, in the method according to the invention (as described above, in particular in methods described as being preferred), the liquid starting mixture comprises each of ethyl methyl carbonate, ethylene carbonate, and diethyl carbonate, wherein the ratio of the weights of ethyl methyl carbonate, ethylene carbonate and diethyl carbonate in the liquid starting mixture preferably is (>1):1:(<1),

or
wherein the liquid starting mixture comprises propylene carbonate, wherein the amount of propylene carbonate in the liquid starting mixture is higher than the amount of any other carbonate in the liquid starting mixture, preferably higher than the total amount of other carbonates, more preferably higher than 50% by weight of the liquid starting mixture, based on the total amount of the liquid starting mixture.

Preferably, in the method according to the invention (as described above, in particular in methods described as being preferred), the liquid starting mixture comprises less than 5% by weight of LiPF₆ as a further constituent, preferably less than 3% by weight, more preferably less than 1% by weight, based on the total amount of the liquid starting mixture, preferably less than 5% by weight of Lithium conducting salts, preferably less than 3% by weight, more preferably less than 1% by weight, based on the total amount of the liquid starting mixture, more preferably less than 5% by weight of conducting salts in total, preferably less than 3% by weight, more preferably less than 1% by weight, based on the total amount of the liquid starting mixture.

More preferably, in the method according to the invention (as described above, in particular in methods described as being preferred) the liquid starting mixture comprises no LiPF₆, preferably no Lithium conducting salts, more preferably no conducting salts at all.

Preferably, in the method according to the invention (as described above, in particular in methods described as being preferred), 70% to 100% by weight of the zeolite molecular sieve material contacted with the liquid starting mixture is a sodium zeolite molecular sieve, preferably a sodium zeolite molecular sieve of Linde Type 4A, based on the total amount of zeolite molecular sieve material contacted with the liquid starting mixture.

The amount of sodium ions in a zeolite molecular sieve material can be determined by XRPD measurements (X-ray powder diffraction).

A binderless sodium zeolite molecular sieve of Linde Type 4A exhibits the typical composition of a unit cell of Na₁₂[AlO₂)₁₂(SiO₂)₁₂]*27 H₂O. This binderless zeolite has, as al-ready described above, a pore size of 4 Angstrom which is well suited to allow water molecules to enter into and get adsorbed within the framework structure. Furthermore, this binderless zeolite is not a substitution-type zeolite, which means that the sodium ions (i.e. the originally present sodium ions) are not replaced to a significant amount by any other type of cations, more preferably not replaced by lithium ions. As a consequence, binderless sodium zeolite molecular sieves of Linde Type 4A are cost efficient and well suited in the method according to the present invention for dehydration of a liquid starting mixture not comprising a lithium conducting salt (see above mentioned dehydration method (i)).

In some cases it is preferred that in the method according to the invention (as described above, in particular in methods described as being preferred) the binderless zeolite molecular sieve is of Linde Type 3A. A binderless zeolite molecular sieve of type 3A has a pore size of 3 Angstrom and is still well suited to allow water molecules to enter into the framework structure. However, the predominant cations are potassium ions (replacing or substituting the originally present sodium ions) in order to arrive at the pore size of 3 Angstrom.

In other cases it is preferred that in the method according to the invention (as described above, in particular in methods described as being preferred) the binderless zeolite molecular sieve is of Linde Type 5A. A binderless zeolite molecular sieve of type 5A has a pore size of 5 Angstrom and is still suited to allow water molecules to enter into the framework structure. However, the predominant cations are calcium ions (replacing or substituting the originally present sodium ions) in order to arrive at the pore size of 5 Angstrom.

Preferably, in the method according to the invention (as described above, in particular in methods described as being preferred), the total amount of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, preferably in the range of from 0 to 33.4% by weight, based on the total amount of the liquid starting mixture, is 92% by weight or more, preferably 94% by weight or more, based on the total amount of the liquid starting mixture.

More preferably, in the method according to the invention (as described above, in particular in methods described as being preferred), the total amount of the one, two, three or more organic carbonates in the liquid starting mixture is 92% by weight or more, preferably 94% by weight or more, based on the total amount of the liquid starting mixture.

Preferably, in the method according to the invention (as described above, in particular in methods described as being preferred), the liquid starting mixture comprises each of ethyl methyl carbonate, ethylene carbonate, and diethyl carbonate, wherein the ratio of the weights of ethyl methyl carbonate, ethylene carbonate and diethyl carbonate in the liquid starting mixture preferably is (>1):1:(<1), and wherein the total amount of ethyl methyl carbonate, ethylene carbonate, and diethyl carbonate in the liquid starting mixture is preferably 95% by weight or more, based on the total amount of the liquid starting mixture.

In some cases a method according to the invention (as described above, in particular methods described as being preferred) is preferred, comprising the step of providing or preparing a liquid starting mixture consisting of
one, two, three or more organic carbonates
water in a total amount of 3500 ppm to 20 ppm preferably in a total amount of 500 ppm to 20 ppm, based on the total amount of the liquid starting mixture,
further constituents in a total amount of 1% by weight or less, based on the total amount of the liquid starting mixture.

In some cases it is preferred that the total amount of further constituents in the liquid starting mixture is 0.1% by weight or less, more preferably no further constituents are present at all in the liquid starting mixture.

Preferably, the aforementioned features, e.g. regarding temperature, pressure, total amount of aluminium ions and silicon ions apply too.

Preferably, in the method according to the invention (as described above, in particular in methods described as being preferred), the total amount of water in the liquid starting mixture is in the range of from 3000 ppm to 20 ppm or in the range of from 2000 ppm to 20 ppm or in the range of from 1000 ppm to 20 ppm or in the range of from 500 ppm to 20 ppm or in the range of from 400 ppm to 20 ppm or in the range of from 300 ppm to 20 ppm or in the range of from 200 ppm to 20 ppm or in the range of from 150 ppm to 20 ppm, based on the total amount of the liquid starting mixture.

Own experiments have often shown that the method according to the invention (as described above, in particular methods described as being preferred) is in particular suited to reduce the water content in the mixture to an amount of less than 20 ppm if in the liquid starting mixture water is present in a total amount of from 3000 ppm to 20 ppm.

Further experiments have also shown that the method according to the invention (as described above, in particular methods described as being preferred) is well suited to reduce the water content in the mixture to an amount of less than 20 ppm in the liquid starting mixture if water is present in quite low concentrations, e. g. in a total amount of from 150 ppm to 20 ppm.

The binderless zeolite molecular sieve for reducing the water content in the liquid mixture may be provided as powder or as shaped bodies, the use of shaped bodies being preferred.

Preferably, no shaped bodies of a binder-containing zeolite molecular sieve are mixed with shaped bodies of the binderless zeolite molecular sieve. However, in some cases a certain amount of shaped bodies of the binder-containing zeolite molecular sieve in admixture with shaped bodies of the binderless molecular sieve is acceptable.

Thus, in the method according to the invention (as described above, in particular in methods described as being preferred) it is preferred, that the binderless zeolite molecular sieve comprises or consists of shaped bodies, preferably of shaped bodies exhibiting a spherical or cylindrical shape.

In some cases, alternative shapes of the shaped bodies are preferred including trefoil, elliptical and hollow shapes.

Preferably, in the method according to the invention (as described above, in particular in methods described as being preferred), the shaped bodies constituting the binderless zeolite molecular sieve, preferably the shaped bodies exhibiting a spherical, cylindrical, trefoil, elliptical or hollow shape, exhibit a maximum diameter in the range of from 0.3 to 5.1 mm, preferably in the range of from 1.6 to 2.5 mm or 2.5 to 5.0 mm.

Shaped bodies exhibiting the aforementioned shapes and maximum diameters are particularly well suited for use in a method of the present invention, in particular in technical large scale productions. Such shaped bodies are easy to handle, in particular for recycling procedures in order to regenerate the binderless zeolite molecular sieve after contact with the liquid starting mixture.

Furthermore, shaped bodies of zeolite molecular sieve materials are in particular suited to be used in dehydration columns in order to:
stabilize the pressure conditions in a dehydration column (or other packed beds),
avoid or reduce the amount of powdery dust,
facilitate the exchange of the zeolite molecular sieve materials in the dehydration column (or other packed beds).

As mentioned above, zeolites are available as natural or synthetic zeolites. Own experiments have revealed that corresponding to the intended use both natural and synthetic binderless zeolites can be used for dehydration. However, in a preferred method according to the invention (as described above, in particular in methods described as being preferred) the zeolite of the binderless zeolite molecular sieve is a synthetically manufactured zeolite.

Synthetically manufactured zeolites are of consistently good quality, exhibit a maximum water adsorption capacity, are cost efficient in comparison to natural zeolites, and comprise very low amounts of contaminations (i.e. foreign ions).

The total amount of further constituents in the liquid starting mixture is preferably in the range of from 0 to 9.65% by weight, more preferably in the range of from 0 to 7% by weight, even more preferably in the range of from 0 to 5% by weight, further preferably in the range of from 0 to 3% by weight, based on the total amount of the liquid starting mixture.

Preferably, in the method according to the invention (as described above, in particular in methods described as being preferred), one, more than one, or all of the further constituents are selected from the group consisting of biphenyl, cyclohexylbenzene, ethylene sulfide, methacrylic acid esters of C1 to C8 alcohols, partly- or perfluorinated methacrylic acid esters of C1 to C8 alcohols, acrylic acid esters of C1 to C8 alcohols and partly- or perfluorinated acrylic acid esters of C1 to C8 alcohols, boronic acid esters of C1 to C8 alcohols, partly- or perfluorinated boronic acid esters of C1 to C8 alcohols, boric acid esters of C1 to C8 alcohols, partly- or perfluorinated boric acid esters of C1 to C8 alcohols, partly- or perfluorinated acetic acid esters of C1 to C8 alcohols, partly- or perfluorinated butyric acid esters of C1 to C8 alcohols, di alkyl sulfides, carboxylic acid nitriles (preferably selected from the group consisting of acrylonitrile and succinonitrile), conducting salts and further additives preferably selected from the group consisting of 1,3-propane sultone, 1,4-butane sultone, 1,5-pentane sultone, phosphoric acid esters of C1 to C8 alcohols, partly- or perfluorinated phosphoric acid esters of C1 to C8 alcohols, phosphorous acid esters of C1 to C8 alcohols and partly- or perfluorinated phosphorous acid esters of C1 to C8 alcohols. More preferably, one, more than one, or all of the further constituents are selected from the group consisting of cyclohexylbenzene, acrylonitrile, methacrylic acid esters of C1 to C8 alcohols, partly- or perfluorinated methacrylic acid esters of C1 to C8 alcohols, acrylic acid esters of C1 to C8 alcohols and partly- or perfluorinated acrylic acid esters of C1 to C8 alcohols.

Preferred partly- or perfluorinated acetic acid esters of C1 to C8 alcohols are partly- or perfluorinated acetic acid methyl ester and acetic acid ethyl ester. Preferred partly- or perfluorinated butyric acid esters of C1 to C8 alcohols are partly- or perfluorinated butyric acid methyl ester and butyric acid ethyl ester.

The total amount of further constituents which are not conducting salts is preferably in the range of from 0 to 7% by weight, more preferably in the range of from 0 to 5% by weight, even more preferably in the range of from 0 to 3% by weight, based on the total amount of the liquid starting mixture.

The preferred feature regarding the one, more than one, or all of the further constituents is preferably combined with features of preferred embodiments of the present invention as described above (in particular with the preferred feature regarding the total amount of LiPF₆, lithium conducting salts and conducting salts at all, respectively) or below.

Biphenyl is an additive used in order to reduce the flammability and/or to prevent over-loading.

Preferred is a method according to the invention (as described above, in particular in methods described as being preferred), wherein the amount of a binderless zeolite molecular sieve is provided as a packed bed, preferably a packed column, loaded with the binderless zeolite molecular sieve.

In some cases a method according to the invention (as described above, in particular methods described as being preferred) is preferred, wherein the amount of a binderless zeolite molecular sieve is provided as a packed bed, preferably a packed column, loaded with the binderless zeolite molecular sieve, wherein the binderless zeolite molecular sieve comprises or consists of shaped bodies, wherein the shaped bodies exhibit a maximum diameter in the range of from 0.3 to 5.1 mm, preferably in the range of from 1.6 to 2.5 mm or 2.5 to 5.0 mm.

Preferred is a method according to the invention (as described above, in particular in methods described as being preferred), wherein the contacting is performed in a packed bed of a dehydration column loaded with the binderless zeolite molecular sieve. The preferred feature regarding the above mentioned contacting in a packed bed of a dehydration column loaded with the binderless zeolite molecular sieve is preferably combined with features of preferred embodiments of the present invention as described above or below, in particular with features regarding the binderless zeolite molecular sieve material.

In a preferred method according to the invention (as described above, in particular in methods described as being preferred) the contacting is performed in a packed bed of a dehydration column loaded with the binderless zeolite molecular sieve (as described above, in particular binderless zeolite molecular sieves described as being preferred), wherein the binderless zeolite molecular sieve comprises or consists of shaped bodies, wherein the shaped bodies exhibit a maximum diameter in the range of from 0.3 to 5.1 mm, preferably in the range of from 1.6 to 2.5 mm or 2.5 to 5.0 mm.

A dehydration column is very well suited to operate in large scale productions to produce dehydrated liquid mixtures, comprising water in an amount of less than 20 ppm. A dehydration column, loaded with the binderless zeolite molecular sieve can be replaced in one piece in order to only shortly interrupt the large scale production. While a first dehydration column is regenerated a second column can be used to continue the large scale production. Furthermore, if a production unit is used for large scale production two dehydration columns can be installed in parallel such that the process is preferably not interrupted at all.

Furthermore, in a packed bed such as a packed column the capacity of the zeolite molecular sieve material is optimally used due to the flow of the liquid starting mixture through the packed bed, preferably through a packed column, containing the zeolite molecular sieve material (as described above, in particular binderless zeolite molecular sieves described as being preferred). Thus, in a large scale production usually better results are obtained than in batch-processes.

It is furthermore preferred that such a method according to the invention is additionally conducted at a pressure of maximum 50 bar, preferably in the range of from very close to zero to 50 bar, more preferably in the range of from 0.5 to 10 bar, most preferably in the range of from 1 to 1.5 bar and at a temperature in the range of from −20 to 100° C., more preferably at a temperature in the range of from −20 to 60° C., most preferably at a temperature in the range of from −20 to 40° C. The preferred feature regarding pressure and temperature is preferably combined with features of preferred embodiments of the present invention as described above or below, in particular with features regarding the total amounts of aluminium ions and silicon ions.

It is most preferred that a method of the present invention (as defined above) for producing a dehydrated liquid mixture comprising water in an amount of less than 20 ppm, for use as a solvent for a conducting salt, consists of the following steps:
providing or preparing a liquid starting mixture (as described above, in particular liquid starting mixtures described as being preferred) comprising
   one, two, three or more organic carbonates (as described above, in particular organic carbonates described as being preferred) in a total amount of 90% by weight or more, based on the total amount of the liquid starting mixture,
   water in a total amount of 3500 ppm to 20 ppm, preferably in a total amount of 500 ppm to 20 ppm, based on the total amount of the liquid starting mixture,
   optionally further constituents (as described above or below, in particular further constituents described as being preferred),
contacting the liquid starting mixture (as described above, in particular liquid starting mixtures described as being preferred) with an amount of a binderless zeolite molecular sieve (as described above, in particular binderless zeolite molecular sieves described as being preferred) such that the water content in the mixture is reduced to an amount of less than 20 ppm, based on the total amount of the dehydrated liquid mixture.

Particularly preferred is a method according to the invention (as described above, in particular in methods described as being preferred), comprising the step of contacting the liquid starting mixture (as described above, in particular liquid starting mixtures described as being preferred) with an amount of a binderless zeolite molecular sieve (as described above, in particular binderless zeolite molecular sieves described as being preferred) such that the water content in the mixture is reduced to an amount of less than 15 ppm, preferably of less than 10 ppm, based on the total amount of the dehydrated liquid mixture.

For a given liquid starting mixture comprising a certain amount of water the skilled person in an attempt to produce a dehydrated liquid mixture comprising water in an amount of less than 20 ppm, and, in particular an amount of water within a predetermined concentration range (below 20 ppm), will select a binderless zeolite molecular sieve material and will conduct a series of simple experiments (analogous to the experiments described in items 1 to 3 in the Examples section) in order to determine the amount of the selected binderless zeolite molecular sieve material providing the required dehydration capacity. By doing so, the skilled person is both able to avoid the use of unnecessary large amounts of binderless zeolite molecular sieve and to avoid the use of too little amounts of binderless zeolite molecular sieve.

It is desired to optimize the total weight of binderless zeolite molecular sieve per total weight of the liquid starting mixture contacted with the binderless zeolite molecular sieve in order to reduce costs and efforts to regenerate the binderless zeolite molecular sieve after the contacting step (i.e. to optimize/increase the efficiency of the dehydration process).

Own studies have often shown that the water content in the liquid starting mixture can be efficiently reduced to an amount of less than 20 ppm but more than 15 ppm, based on the total amount of the dehydrated liquid mixture. This means that a dehydrated liquid mixture (as described above, in particular dehydrated liquid mixtures described as being preferred), wherein the water content is less than 20 ppm but more than 15 ppm can be produced by contacting the liquid starting mixture (as described above, in particular liquid starting mixtures described as being preferred) with a defined (and relatively low) amount of binderless zeolite molecular sieve (as described above, in particular binderless zeolite molecular sieves described as being preferred).

Thus, preferred is a method according to the invention (as described above, in particular in methods described as being preferred), comprising or consisting of the following steps:
providing or preparing a liquid starting mixture (as described above, in particular liquid starting mixtures described as being preferred) comprising
   one, two, three or more organic carbonates (as described above, in particular organic carbonates described as being preferred) in a total amount of 90% by weight or more, based on the total amount of the liquid starting mixture (as described above, in particular liquid starting mixtures described as being preferred),
   water in a total amount of 500 ppm to 100 ppm, preferably 200 ppm to 100 ppm, based on the total amount of the liquid starting mixture,
   optionally further constituents (as described above, in particular further constituents described as being preferred),
contacting the liquid starting mixture (as described above, in particular liquid starting mixtures described as being preferred) with an amount of a binderless zeolite molecular sieve (as described above, in particular binderless zeolite molecular sieves described as being preferred) such that the water content in the mixture is reduced to an amount of
(i) less than 20 ppm but more than 15 ppm, based on the total amount of the dehydrated liquid mixture, wherein the ratio of the total weight of the liquid starting mixture and the total weight of the binderless zeolite molecular sieve contacted therewith is in the range of from 1100 to 180 kilogram liquid starting mixture per kilogram binderless zeolite molecular sieve, preferably in the range of from 1100 to 550 kilogram liquid starting mixture per kilogram binderless zeolite molecular sieve, more preferably in the range of from 1100 to 600 kilogram liquid starting mixture per kilogram binderless zeolite molecular sieve, most preferably in the range of from 1100 to 700 kilogram liquid starting mixture per kilogram binderless zeolite molecular sieve,
   or
(ii) 15 ppm to 8 ppm, based on the total amount of the dehydrated liquid mixture, wherein the ratio of the total weight of the liquid starting mixture and the total weight of the binderless zeolite molecular sieve contacted therewith is in the range of from 650 to 120 kilogram liquid starting mixture per kilogram binderless zeolite molecular sieve, preferably is in the range of from 650 to 300 kilogram liquid starting mixture per kilogram binderless zeolite molecular sieve, more preferably in the range of from 650 to 350 kilogram liquid starting mixture per kilogram binderless zeolite molecular sieve, most preferably in the range of from 650 to 400 kilogram liquid starting mixture per kilogram binderless zeolite molecular sieve.

Own experiments have shown that the use of a binderless zeolite molecular sieve is usually more efficient than the use of a (conventional, i.e. binder-containing) zeolite molecular sieve of the same type (see Table 2 and 3 in the Examples section).

In particular, the method according to the invention is very efficient in reducing the water content in the liquid starting mixture to an amount of less than 20 ppm, based on the total amount of the dehydrated liquid mixture.

In some cases, preferred is a method according to the invention (as described above, in particular in methods described as being preferred), wherein the liquid starting mixture comprises each of ethyl methyl carbonate, ethylene carbonate, and diethyl carbonate, wherein the ratio of the weights of ethyl methyl carbonate, ethylene carbonate and diethyl carbonate in the liquid starting mixture preferably is (>1):1:(<1), and wherein the total amount of ethyl methyl carbonate, ethylene carbonate, and diethyl carbonate in the liquid starting mixture is 95% by weight or more, based on the total amount of the liquid starting mixture, and wherein the water content in the mixture is reduced to an amount of
(i) less than 20 ppm but more than 15 ppm, based on the total amount of the dehydrated liquid mixture, wherein the ratio of the total weight of the liquid starting mixture and the total weight of the binderless zeolite molecular sieve contacted therewith is in the range of from 1100 to 180 kilogram liquid starting mixture per kilogram binderless zeolite molecular sieve, preferably in the range of from 1100 to 550 kilogram liquid starting mixture per kilogram binderless zeolite molecular sieve, more preferably in the range of from 1100 to 600 kilogram liquid starting mixture per kilogram binderless zeolite molecular sieve, most preferably in the range of from 1100 to 700 kilogram liquid starting mixture per kilogram binderless zeolite molecular sieve,
   or
(ii) 15 ppm to 8 ppm, based on the total amount of the dehydrated liquid mixture, wherein the ratio of the total weight of the liquid starting mixture and the total weight of the binderless zeolite molecular sieve contacted therewith is in the range of from 650 to 120 kilogram liquid starting mixture per kilogram binderless zeolite molecular sieve, preferably is in the range of from 650 to 300 kilogram liquid starting mixture per kilogram binderless zeolite molecular sieve, more preferably in the range of from 650 to 350 kilogram liquid starting mixture per kilogram binderless zeolite molecular sieve, most preferably in the range of from 650 to 400 kilogram liquid starting mixture per kilogram binderless zeolite molecular sieve.

After contacting the liquid starting mixture with an amount of the binderless zeolite molecular sieve such that the water content in the mixture is reduced to an amount of less than 20 ppm, based on the total amount of the dehydrated liquid mixture, the binderless zeolite molecular sieve usually contains mobile water molecules which may be removed, usually reversibly, by heat and/or evacuation (reduced pressure). However, to a certain degree such mobile water molecules might be also present in the binderless zeolite molecular sieve before contacting the liquid starting mixture with an amount of a binderless zeolite molecular sieve. This is for example the case if the binderless zeolite molecular sieve was in contact with ambient air for a few hours prior to use in a method according to the invention. The amount of preloaded water in the binderless zeolite molecular sieve can be determined by loss on drying measurements of the binderless zeolite molecular sieve in a muffle furnace at 300° C. over night.

In some cases it is preferred that in the method according to the invention (as described above, in particular in methods described as being preferred) the binderless zeolite molecular sieve (as described above, in particular binderless zeolite molecular sieves described as being preferred) contains water in the range of from 0 to 5 g per 100 g binderless zeolite molecular sieve, preferably in the range of from 1 to 5 g per 100 g binderless zeolite molecular sieve before contacting the liquid starting mixture (as described above, in particular liquid starting mixtures described as being preferred) with the amount of the binderless zeolite molecular sieve. In other terms, the binderless zeolite molecular sieve is preloaded with water molecules.

Own experiments have shown that the water content in the dehydrated liquid mixture to be produced can be reduced to less than 20 ppm even when contacting the liquid starting mixture with an amount of a binderless zeolite molecular sieve being preloaded with water in the range of from 0 to 5 g per 100 g binderless zeolite molecular sieve. It is, however, more preferred that the preloaded water is in the range of from 0 to 3 g per 100 g binderless zeolite molecular sieve, and even more preferably the binderless zeolite molecular sieve is preloaded with no water at all.

Allowing a water preload in the range of from 0 to 5 g per 100 g binderless zeolite molecular sieve, preferably in the range of from 0 to 3 g per 100 g binderless zeolite molecular sieve, allows for short regeneration cycles of the binderless zeolite molecular sieve as because residual amounts of water (i.e. less than 5 g per 100 g binderless zeolite molecular sieve) in the binderless zeolite molecular sieve do not need to be removed by heat and/or evacuation. Thus, energy can be saved in recycling.

A second aspect of the present invention relates to a method of producing an electrolyte mixture comprising the following steps:
producing a dehydrated liquid mixture, (preferably according to a method according to the first aspect of the present invention as described above, in particular dehydrated liquid mixture described as being preferred) comprising water in a total amount of less than 20 ppm,
mixing the dehydrated liquid mixture with one or more conducting salts and optionally with further ingredients.

Preferably, in this method according to the invention the one or more conducting salts are selected from the group consisting of lithium perchlorate (LiClO₄), lithium tetrafluoroborate (LiBF₄), lithium trifluoro tris(pentafluoroethyl)phosphate (LiPF₃(C₂F₅)₃), lithium bis(trifluoromethanesulfonyl)imide (LiN(SO₂CF₃)₂), lithium bis(fluorosulfonyl)imide (LiN(SO₂F)₂), lithium difluorooxalatoborate (LiBF₂(C₂O₄)), lithium hexafluorophosphate (LiPF₆) and lithium bis(oxalato)borate (LiB(C₂O₄)₂). More preferably, the conducting salt is lithium hexafluorophosphate (LiPF₆), lithium trifluoro tris-(pentafluoroethyl)phosphate (LiPF₃(C₂F₅)₃) and lithium bis(fluorosulfonyl)imide (LiN(SO₂F)₂).

Furthermore preferably, in this method according to the invention the further ingredients are selected from the group consisting of vinylene carbonate, vinyl ethylene carbonate, cyclohexylbenzene, succinic anhydride, ethenyl sulfonyl benzene, ethyl acetate and exo vinylene carbonates, preferably exo vinylene carbonates selected from the group consisting of 4,4-dimethyl-5-methylene-1,3-dioxolan-2-one, 4-methyl-5-methylene-1,3-dioxolan-2-one and 4-methylene-1,3-dioxolan-2-one.

The aforementioned further ingredients improve (i.e. prolong) the battery life span. For more details reference is made for example to EP 1 83674681 B1, paragraph [0024].

In the method according to the second aspect of the present invention (as described above, in particular in methods described as being preferred) one or more conducting salts and optionally further ingredients are added after the dehydrated liquid mixture is produced (i.e. after dehydration of the liquid starting mixture).

The conducting salts as well as the further ingredients are preferably in dry conditions (e.g. their total amount of water is less than 20 ppm) before mixing them with the dehydrated liquid mixture (as described above, in particular dehydrated liquid mixtures described as being preferred).

Furthermore, the method according to the second aspect of the present invention and preferred features thereof are preferably combined with features of preferred embodiments of the first aspect of the present invention as described above.

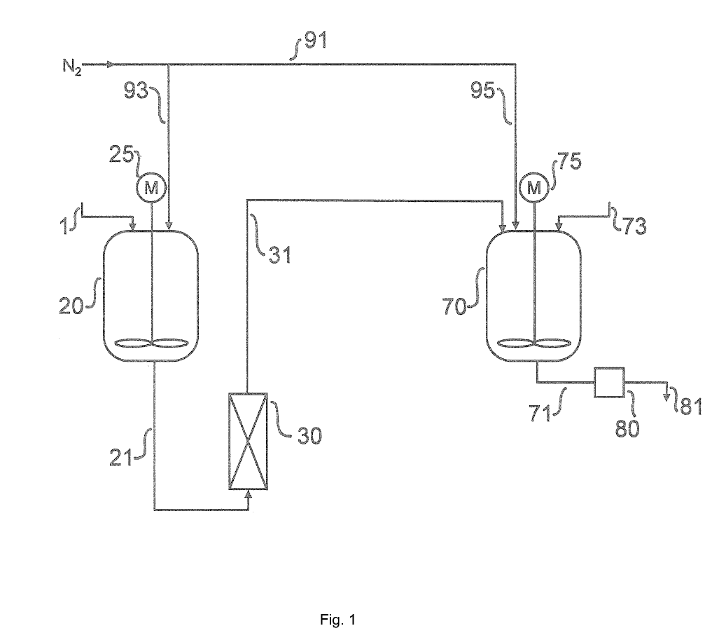

An example of such a production unit is shown in FIG. 1.

FIG. 1 diagrammatically shows a production unit for producing an electrolyte mixture, comprising a feed line 1 connected with a first mixing unit 20. The first mixing unit 20 comprises a first agitator 25 for a first mixing process. The first mixing unit 20 is connected by means of duct 21 with a dehydration unit 30 comprising a packed bed of a dehydration column loaded with shaped bodies of binderless zeolite molecular sieve material. The outlet side of the dehydration unit 30 is connected by means of duct 31 with a second mixing unit 70, connected to a feed line 73 (for providing a feed of one or more conducting salts and optionally further ingredients) and comprising a second agitator 75 for a second mixing process. The outlet of the second mixing unit 70 is connected with a filter unit 80 by means of duct 71. Connected with the outlet side of the filter unit 80 is an effluent duct 81 for product withdrawal.

A nitrogen feed line 91 is connected with the first and second mixing unit 20 and 70, respectively, via two individual transfer ducts 93 and 95, respectively, in order to ventilate said mixing units with nitrogen gas while the mixing units are filled or emptied.

For conducting a method of the present invention the organic carbonates and optional further constituents of a liquid starting mixture are filled into the first mixing unit 20 by means of feed line 1. With mixing by first agitator 25 the organic carbonates and optional further constituents of the liquid starting mixture are mixed in the first mixing unit 20 to produce the liquid starting mixture. The liquid starting mixture is transferred by means of duct 21 into dehydration unit 30 for dehydration. In the dehydration unit 30 the liquid starting mixture is contacted with the binderless zeolite molecular sieve material such that the water content in said liquid starting mixture is reduced to an amount of less than 20 ppm. After dehydration in dehydration unit 30 a dehydrated liquid mixture is produced. The dehydrated liquid mixture is transferred into the second mixing unit 70 by means of duct 31. Into the second mixing unit 70 additionally one or more conducting salts and optionally further ingredients are added by means of feed line 73 and subsequently mixed with the dehydrated liquid mixture by second agitator 75 to produce an electrolyte mixture. The electrolyte mixture produced in the second mixing unit 70 is transported to the filter unit 80 by means of duct 71. After filtration of the electrolyte mixture in filter unit 80 (in order to remove abrasion products of the binderless zeolite molecular sieve material) the filtered electrolyte mixture is withdrawn from the process by the effluent duct 81.

The present invention is described below in more detail by reference to Examples.

### EXAMPLES

### 1. Liquid Starting Mixtures

In Table 1 six liquid starting mixtures (Samples (I) to (VI)) are shown, comprising two, three or more organic carbonates in a total amount of 90% by weight or more, based on the total amount of the liquid starting mixture, and water in a total amount in the range of from 116 ppm to 400 ppm (0.0116 to 0.04% by weight), based on the total amount of the liquid starting mixture.

Sample (I) is an example of a liquid staring mixture comprising each of ethyl methyl carbonate, ethylene carbonate, and diethyl carbonate, wherein the ratio of the weights of ethyl methyl carbonate, ethylene carbonate and diethyl carbonate is (>1):1:(<1), to based on the total amount of the liquid starting mixture, and wherein the total amount of ethyl methyl carbonate, ethylene carbonate, and diethyl carbonate in the liquid starting mixture is 95% by weight or more (97% by weight), based on the total amount of the liquid starting mixture.

TABLE 1
liquid starting mixtures

| | Sample | Sample | Sample | Sample | Sample | Sample |
|---|---|---|---|---|---|---|
| | (I) | (II) | (III) | (IV) | (V) | (VI) |
| compound | % by weight | | | | | |
| dimethyl | — | — | — | 2.9884 | 2.9868 | 2.9847 |
| carbonate | | | | | | |
| diethyl | 16 | — | 24.98 | 16 | 16 | 16 |
| carbonate | | | | | | |
| ethyl | 45 | 24.98 | — | 45 | 45 | 45 |
| methyl | | | | | | |
| carbonate | | | | | | |
| ethylene | 36 | — | — | 36 | 36 | 36 |
| carbonate | | | | | | |
| propylene | — | 74.98 | 74.98 | — | — | — |
| carbonate | | | | | | |
| water | 0.04 | 0.04 | 0.04 | 0.0116 | 0.0132 | 0.0153 |
| biphenyl | 2.96 | — | — | — | — | — |

Biphenyl (a further constituent according to the method of the present invention and present in Sample (I)) is an additive widely used in lithium ion batteries in order to reduce the flammability.

The dehydration procedure is described in detail in the next section.

### 2. Dehydration/Drying Procedure

The dehydration of liquid starting mixtures as defined in Table 1 was carried out according to the following procedure:
The following steps were carried out in a nitrogen purged glove box in order to avoid water desorption through the humidity of ambient air. In a first step, the liquid starting mixtures were prepared by weighing and mixing the compounds of the liquid starting mixtures (see Table 1) in glass flasks. The zeolite molecular sieves 4A (according to the present invention: binderless sodium zeolite molecular sieve 4A: BASF 4ABF Molecular Sieve (maximum diameter of the shaped bodies: in the range of from 1.6 to 2.5 mm, shape: spherical shape); for comparison: binder-containing zeolite molecular sieve 4A: BASF 4A Molecular Sieve (maximum diameter of the shaped bodies: in the range of from 1.6 to 2.5 mm, shape: spherical shape)) were also weighed and in a second step added to the prepared liquid starting mixtures in order to contact the zeolite molecular sieves 4A with the respective liquid starting mixtures. After the second step, the glass flasks were sealed with a cap (GI 45 cap) exhibiting a hole (diameter 5 mm), sealed with a septum in order to take samples. The total volume of the glass flasks was 250 ml. The volume of the liquid starting mixture and the amount of zeolite molecular sieve 4A of each respective sample is shown in the tables of section 3 “Dehydration/drying results”.
The contacting of the liquid starting mixtures and the zeolite molecular sieves 4A was carried out in the sealed glass flasks for 24 hours at 25° C. with constant shaking in a shaking cabinet which was purged with nitrogen during the dehydration procedure.
For the determination of the water content (after 24 hours), a sample of the supernatant was taken with a syringe through the septum of the cap. Analysis was immediately carried out by coulometric Karl-Fischer measurement.
After dehydration, the dehydrated liquid mixtures were separated from their respective molecular sieve materials. As a result, the dehydrated liquid mixtures (according to the invention) can be used for production of electrolyte mixtures (see items 4 and 5 below).
Syringes and needles were pre-dried in a desiccator for at least 48 hours.
The zeolite molecular sieves were unpacked and handled exclusively in a glove box under nitrogen atmosphere. The BASF 4ABF Molecular Sieve is a synthetically manufactured sodium binderless zeolite molecular sieve 4A with the formula Na₂O.Al₂O₃.2 SiO₂.n H₂O and is an example of a preferred binderless zeolite molecular sieve, wherein 70% to 100% by weight of the zeolite molecular sieve material contacted with the liquid starting mixture is a sodium zeolite molecular sieve.

The results of the dehydration/drying procedure are shown in the following section.

### 3. Dehydration/Drying Results

The following terms are used hereinafter:

Volume [ml] denotes the volume of the liquid starting mixture (before contacting with the zeolite molecular sieve material).

H₂O [ppm] denotes the total amount of water in the dehydrated liquid mixture after contacting the liquid starting mixture with the amount of a zeolite molecular sieve.

The term “ratio” in Table 6 denotes the ratio of the total weight of the liquid starting mixture (in kg) and the total weight of the binderless zeolite molecular sieve (in kg) contacted therewith.

### Sample (I):

Relative humidity: —in the laboratory: 19.5%
in the glove box: 0.0%

TABLE 2
dehydration/drying results of Sample (I) using
binderless zeolite molecular sieve 4A

| | Amount of binderless | |
|---|---|---|
| Volume | zeolite molecular | H₂O |
| [ml] | sieve 4A [g] | [ppm] |
| 50 | 0.524 | 4.6 |
| 100 | 0.616 | 7.6 |
| 50 | 5.492 | 3.0 |

TABLE 3
dehydration/drying results of a comparison sample using
Sample (I) but in combination with binder-containing
zeolite molecular sieve 4A as mentioned above

| | Amount of binder-containing | |
|---|---|---|
| Volume | zeolite molecular | H₂O |
| [ml] | sieve 4A [g] | [ppm] |
| 50 | 0.540 | 10.7 |
| 100 | 0.650 | 16.0 |

The results of Sample (I) (Table 2) show that the water content in Sample (I) was reduced to an amount of less than 20 ppm after contacting the mixture with the above mentioned amounts of binderless zeolite molecular sieve 4A. The results even show that the water content was reduced to an amount of less than 10 ppm.

The results of the comparison experiment (Table 3, Sample (I) in combination with a binder-containing zeolite molecular sieve 4A as mentioned above) show that the water content was reduced to an amount of less than 20 ppm. However, the total amount of water in the respective dehydrated liquid mixtures is more than twice as high as in the respective dehydrated liquid mixtures dehydrated by contacting with binderless zeolite molecular sieves (see Table 2). Surprisingly, the resulting total amount of water in 100 ml of the comparison experiment is 2.1 times higher compared to the resulting total amount of water in the experiment according to the invention (Table 2) although the total amount of zeolite molecular sieve used according to Table 2 was only approximately 95% by weight of the total amount of zeolite molecular sieve used in said comparison experiment (see Table 3). Thus, the use of a binderless zeolite molecular sieve 4A is surprisingly and significantly more efficient than expected in comparison with the use of a binder-containing zeolite molecular sieve 4A.

Furthermore, the results in Table 2 show that an approximately 10-times increase of the total amount of binderless zeolite molecular sieve 4A (5.492 gram) leads to a further reduction of the total amount of water in the mixture. However, large amounts of binderless zeolite molecular sieve 4A (e.g. a 10-fold increase) are not needed in order to efficiently reduce the total amount of water in the mixture to less than 20 ppm.

### Sample (II):

Relative humidity: —in the laboratory: 20%
in the glove box: 0.0%

TABLE 4
dehydration/drying results of Sample (II)
using binderless zeolite molecular sieve 4A

| | Amount of binderless | | | | Silicon |
|---|---|---|---|---|---|
| Volume | zeolite molecular | H₂O | Na | Al | ions |
| [ml] | sieve 4A [g] | [ppm] | [ppm] | [ppm] | [ppm] |
| 100 | 0.608 | 16.0 | <1 | <1 | <1 |

The results of Sample (II) show that the water content in Sample (II) was reduced to an amount of less than 20 ppm after contacting the mixture with the above mentioned amounts of binderless zeolite molecular sieve 4A.

The results furthermore show that the dehydrated liquid mixture is of high purity because the individual concentration of aluminium ions and silicon ions is below 1 ppm.

### Sample (Ill):

Relative humidity: —in the laboratory: 20%
in the glove box: 0.0%

TABLE 5
dehydration/drying results of Sample (III)
using binderless zeolite molecular sieve 4A

| | Amount of binderless | | | | Silicon |
|---|---|---|---|---|---|
| Volume | zeolite molecular | H₂O | Na | Al | ions |
| [ml] | sieve 4A [g] | [ppm] | [ppm] | [ppm] | [ppm] |
| 100 | 0.616 | 12.9 | < 1 | <1 | <1 |

The results of Sample (Ill) show that the water content in Sample (Ill) was reduced to an to amount of less than 20 ppm, even to an amount of less than 15 ppm, after contacting the mixture with the above mentioned amounts of binderless zeolite molecular sieve 4A.

The results furthermore show that the dehydrated liquid mixture is of high purity because the individual concentration of aluminium ions and silicon ions is below 1 ppm.

### Samples (IV) to (VI):

TABLE 6
dehydration/drying results of samples (IV) to (VI)
using binderless zeolite molecular sieve 4A

| | Mass of liquid | Amount of binderless | | |
|---|---|---|---|---|
| | starting mixture | zeolite molecular | H₂O | |
| Sample | [g] | sieve 4A [g] | [ppm] | ratio |
| Sample (IV) | 1000 | 0.92 | 19.2 | 1087 |
| Sample (V) | 1000 | 1.11 | 18.5 | 901 |
| Sample (VI) | 1000 | 1.41 | 16.1 | 709 |

The results (shown in Table 6) show that the total amount of water in the dehydrated liquid mixture was reduced to less than 20 ppm but more than 15 ppm. Furthermore, the ratio of the total weight of the liquid starting mixture and the total weight of the binderless zeolite molecular sieve contacted therewith is in the preferred range of from 1100 to 700 kilogram liter liquid starting mixture per kilogram binderless zeolite molecular sieve.

### 4. Production of an Electrolyte Mixture

### 4.1 Electrolyte Mixture 1

In a first step, Sample (II) was prepared and dehydrated as described above. In a second step, the produced dehydrated Sample (II) was mixed with water-free lithium hexafluorophosphate (LiPF₆) as follows: 87.8% by weight dehydrated Sample (II) and 12.2% by weight water-free lithium hexafluorophosphate (LiPF₆).

### 4.2 Electrolyte Mixture 2

Electrolyte mixture 2 was prepared by mixing electrolyte mixture 1 (as prepared in 4.1) with water-free lithium bis(fluorosulfonyl)imide (LiN(SO₂F)₂) as follows: 99% by weight of electrolyte mixture 1 and 1% by weight water-free lithium bis(fluorosulfonyl)imide (LiN(SO₂F)₂).

### 4.3 Electrolyte Mixture 3

Electrolyte mixture 3 was prepared by mixing electrolyte mixture 1 (as prepared in 4.1) with water-free vinylene carbonate as follows: 98% by weight of electrolyte mixture 1 and 2% by weight water-free vinylene carbonate.

The mixing for each electrolyte mixture was carried out in glass flasks, respectively, with constant stirring for 15 minutes in a nitrogen purged glove box in order to avoid water desorption through the humidity of ambient air. After the mixing process, each individual flask was sealed.

### 5. Large-Scale Production of an Electrolyte Mixture

In the method for producing an electrolyte mixture a large-scale production was carried out wherein the contacting of the liquid starting mixture with the binderless zeolite molecular sieve was performed in a packed bed of a dehydration column loaded with binderless zeolite molecular sieve. The production took place in a production unit as shown in FIG. 1 carrying out a method comprising the following essential steps:
flushing of the mixing units 20 and 70 by applying pre-dried nitrogen gas in order to dehydrate the equipment of the production unit (total amount of water in the nitrogen gas: below 5 ppm)
production of the liquid starting mixture in the first mixing unit 20
dehydration of the liquid starting mixture in the dehydration unit 30 at a flow rate of 300 liter per hour
mixing of the dehydrated liquid mixture in the second mixing unit 70 with LiPF₆
filtration of the electrolyte mixture in filter unit 80

1. A method for producing a dehydrated liquid mixture comprising water in an amount of less than 20 ppm, the method comprising contacting a liquid starting mixture with an amount of a binderless zeolite molecular sieve, such that a water content of the liquid starting mixture is reduce to less than 20 ppm based a total amount of the liquid starting mixture,
wherein the liquid starting mixture comprises:
a total amount of 90% by weight or more, based on the total amount of the liquid starting mixture, of at least one compound selected from the group consisting of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture; and
water in a total amount of 3500 ppm to 20 ppm, based on the total amount of the liquid starting mixture; and.

2. The method of claim 1, wherein the liquid starting mixture comprises at least one carbonate of (I): 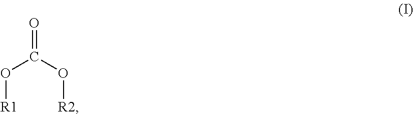
wherein:
R1 and R2 independently denote an alkyl group having one or more carbon atoms; or
R1 and R2 together constitute a substituted or unsubstituted alkylene bridge linking the esterified oxygens of the diester.

3. The method of claim 1, wherein the liquid starting mixture comprising at least one organic carbonate selected from the group consisting of dimethyl carbonate, diethyl carbonate, ethyl methyl carbonate, propylene carbonate, fluoroethylene carbonate, 4,4-dimethyl-5-methylene-1,3-dioxolan-2-one, 4-methyl-5-methylene-1,3-dioxolan-2-one, 4-methylene-1,3-dioxolan-2-one, vinyl ethylene carbonate and ethylene carbonate.

4. The method of claim 1, wherein 70% to 100% by weight of the zeolite molecular sieve material contacted with the liquid starting mixture is a sodium zeolite molecular sieve, based on the total amount of zeolite molecular sieve material contacted with the liquid starting mixture.

5. The method of claim 1, wherein the liquid starting mixture comprises 92% by weight or more of at least one organic carbonate, based on the total amount of the liquid starting mixture.

6. The method of claim 1, wherein the liquid starting mixture comprises ethyl methyl carbonate, ethylene carbonate, and diethyl carbonate.

7. The method of claim 1, wherein the total amount of water in the liquid starting mixture is in the range of from 3000 ppm to 20 ppm based on the total amount of the liquid starting mixture.

8. The method of claim 1, wherein the binderless zeolite molecular sieve comprises shaped bodies.

9. The method of claim 1, wherein the zeolite of the binderless zeolite molecular sieve is a synthetically manufactured zeolite.

10. The method of claim 1, wherein the liquid starting mixture further comprises at least one further constituent selected from the group consisting of biphenyl, cyclohexylbenzene, ethylene sulfide, methacrylic acid esters of C1 to C8 alcohols, partly- or perfluorinated methacrylic acid esters of C1 to C8 alcohols, acrylic acid esters of C1 to C8 alcohols and partly- or perfluorinated acrylic acid esters of C1 to C8 alcohols, boronic acid esters of C1 to C8 alcohols, partly- or perfluorinated boronic acid esters of C1 to C8 alcohols, boric acid esters of C1 to C8 alcohols, partly- or perfluorinated boric acid esters of C1 to C8 alcohols, partly- or perfluorinated acetic acid esters of C1 to C8 alcohols, partly- or perfluorinated butyric acid esters of C1 to C8 alcohols, di alkyl sulfides, carboxylic acid nitriles, conducting salts, phosphoric acid esters of C1 to C8 alcohols, partly- or perfluorinated phosphoric acid esters of C1 to C8 alcohols, phosphorous acid esters of C1 to C8 alcohols and partly- or perfluorinated phosphorous acid esters of C1 to C8 alcohols.

11. The method of claim 1, wherein the binderless zeolite molecular sieve is present as a packed bed, loaded with the binderless zeolite molecular sieve.

12. The method of claim 1, wherein the contacting is performed in a packed bed of a dehydration column loaded with the binderless zeolite molecular sieve.

13. The method of claim 1, comprising contacting the liquid starting mixture with an amount of the binderless zeolite molecular sieve such that the water content in the mixture is reduced to an amount of less than 15 ppm based on the total amount of the dehydrated liquid mixture.

14. The method of claim 1, comprising contacting a liquid starting mixture with an amount of a binderless zeolite molecular sieve such that a water content of the liquid starting mixture is reduced to an amount of:
(i) less than 20 ppm but more than 15 ppm, based on a total amount of dehydrated liquid mixture, wherein a ratio of a total weight of the liquid starting mixture and a total weight of the binderless zeolite molecular sieve contacted therewith is in the range of from 1100 to 180 kilogram liquid starting mixture per kilogram binderless zeolite molecular sieve,
or
(ii) 15 ppm to 8 ppm, based on the total amount of the dehydrated liquid mixture, wherein the ratio of the total weight of the liquid starting mixture and the total weight of the binderless zeolite molecular sieve contacted therewith is in the range of from 650 to 120 kilogram liquid starting mixture per kilogram binderless zeolite molecular sieve,
wherein the liquid starting mixture comprises:
at least one organic carbonate in a total amount of 90% by weight or more based on the total amount of the liquid starting mixture, and
water in a total amount of 500 ppm to 100 ppm based on the total amount of the liquid starting mixture.

15. A method of producing an electrolyte mixture, the method comprising
mixing the dehydrated liquid mixture of claim 1 with one or more conducting salts and optionally with further ingredients.
